(19) United States
(12) Patent Application Publication
(10) Pub. No.: US 2008/0197783 A1
(43) Pub. Date: Aug. 21, 2008

(54) Composite illumination module

(76) Inventor: Chia-Teh Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/707,963

(22) Filed: Feb. 20, 2007

(51) Int. Cl. H05B 39/04

(52) U.S. Cl. 315/153

(57) ABSTRACT

A composite illumination module includes at least one first light-emitting element, a light-emitting unit, and a control circuit assembly, and further has a motion sensor. The light-emitting unit has a circuit board and at least one second light-emitting element electrically connected with the circuit board. The wattage and the intensity of the first light-emitting element are higher than those of the second light-emitting element. The control circuit assembly is electrically connected with the first light-emitting element and the light-emitting unit so as to electrically control the first and second light-emitting elements to selectively emit light. The motion sensor is electrically connected with the control circuit assembly. With this arrangement, the present invention can provide an indicative or guiding effect at a far distance, and provide a common illumination at a close distance using less electricity than in prior art models.

### BACKGROUND OF THE INVENTION

1. Field of the Invention

The present invention relates to a composite illumination module, and in particular to an illumination module in which the luminous intensity thereof is changeable.

2. Description of Related Art

Most lamps use conventional incandescent bulbs, they consume a lot of electricity after long-term use, increasing power bills spending for government, business and homes. Therefore, in order to reduce electricity consumption and improve safety, many manufacturers connect the lamp with a motion sensor. When the motion sensor detects the approach of a person or other creatures, the lamp will automatically turn on. After a period in which no more movement is further detected, the lamp will automatically turn off, thereby avoiding the unnecessary consumption of electricity when illumination is no longer needed.

However, according to practical experience, there is still a drawback existing in the lamp associated with the motion sensor. When the people move outside the detecting range of the motion sensor, there is no illumination. Therefore, the surrounding environment is dark and the person cannot recognize their surroundings. Especially, when the residential environment is an open region, the person needs to grope their way back to his/her house in the dark. As a result, frequent accidents happen.

According to the above, it is an important matter to design an illumination device with a feature of being able to provide a low power consumption guiding illumination at a far distance and a high power consumption illumination at a close distance, thereby saving the unnecessary consumption of electricity.

### SUMMARY OF THE INVENTION

The primary object of the present invention is to provide a composite illumination module which provides an indicative or guiding effect at a far distance while providing a common illumination at a close distance, thereby saving electricity consumption.

In order to achieve the above objects, the present invention provides a composite illumination module comprising at least one first light-emitting element; a light-emitting unit having a circuit board and at least one second light-emitting element electrically connected with the circuit board, the wattage of the first light-emitting element is higher than that of the second light-emitting element; and a control circuit assembly electrically connected with the first light-emitting element and light-emitting unit so as to electrically control the first and second light-emitting elements to selectively emit light; and further comprising a motion sensor electrically connected with the control circuit assembly, thereby detecting the approach of creatures and thus activate the first light-emitting element to emit light.

The first light-emitting element may be a bulb, and the second light-emitting element is a light-emitting diode with low wattage and low electricity consumption.

The present invention has the following effects. The second light-emitting element having a low wattage and low electricity consumption can provide an indicative or guiding effect at a far distance, so that a person can recognize their surroundings. Thus, accidents caused by insufficient light can be avoided. Further, when a person approaches, the second light-emitting element can be switched to the first light-emitting element having a higher wattage and intensity, thereby providing high-intensity illumination at a close distance. With the permanent illumination of the second light-emitting element having a feature of low wattage and low electricity consumption, energy is constantly saved.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is an exploded perspective view showing the first embodiment of the present invention and a lamp seat means;

FIG. 2 is another exploded perspective view showing the first embodiment of the present invention and a lamp seat means;

FIG. 3 is a partially assembled view showing the first embodiment of the present invention and a lamp seat means;

FIG. 4 is an exploded perspective view showing the first embodiment of the present invention, a lamp seat means and an external lamp frame;

FIG. 5 is another exploded perspective view showing the first embodiment of the present invention, a lamp seat means and the external lamp frame;

FIG. 6 is a perspective view showing the fixing base and light-emitting unit in FIG. 5 taken from another view angle;

FIG. 7 is an exploded perspective view showing the first embodiment of the present invention combined with another lamp seat means;

FIG. 8 is another exploded perspective view showing the first embodiment of the present invention combined with another lamp seat means;

### DETAILED DESCRIPTION OF PREFERRED EMBODIMENTS

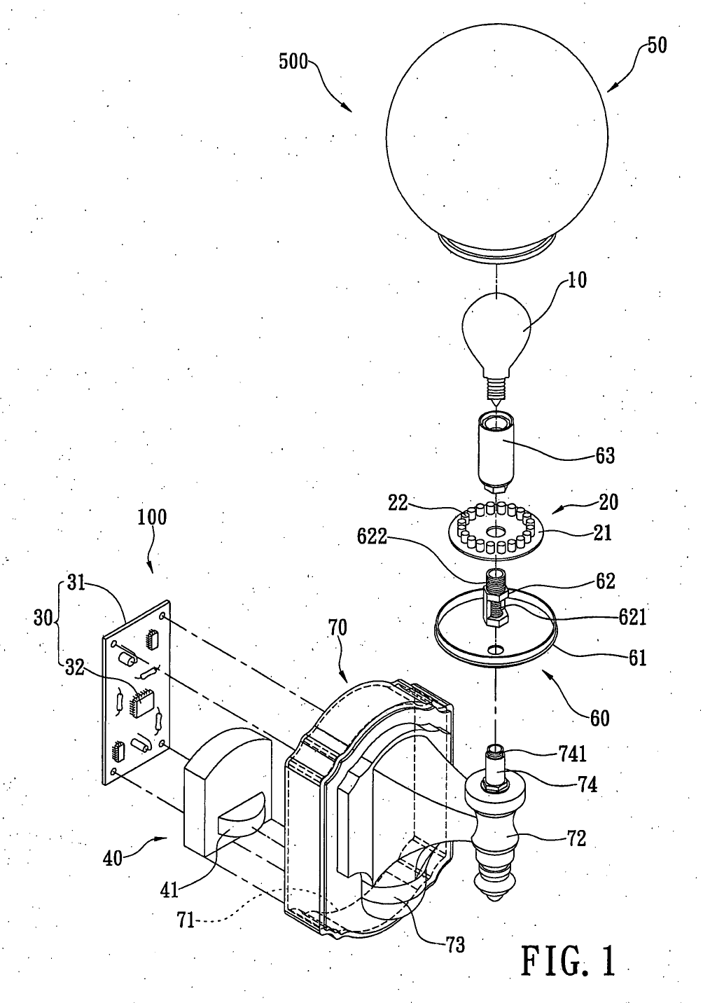

With reference to FIG. 1 the first embodiment of the present invention is shown. The present invention provides a composite illumination module 100, which comprises at least one light-emitting element 10, a light-emitting unit 20, and a control circuit assembly 30. Further, the present invention can comprise a motion sensor 40.

Light-emitting unit 20 has a circuit board 21 and at least a second light-emitting element 22 electrically connected on the circuit board 21. The control circuit assembly 30 has a control circuit board 31 and a plurality of electronic elements 32 (such as a resistor, a capacitor and a control IC) assembled on the control circuit board 31.

The control circuit assembly 30 is electrically connected to the first light-emitting element 10 and light-emitting unit 20. The motion sensor 40 is electrically connected to the control circuit assembly 30. In addition, when the first light-emitting element 10 emits light, the intensity (wattage) thereof is higher than that of the second light-emitting element 22.

The control circuit assembly 30 electrically controls the first and second light-emitting elements 10, 22, so that both of them can selectively emit light. That is to say, the second light-emitting element 22 can be controlled to emit light permanently while the first light-emitting element 10 can emit light temporarily. Alternatively, when the second light-emitting element 22 permanently emits light while the first light-emitting element 10 emits light temporarily, the second light-emitting element 22 is controlled to temporarily stop emitting light. When the first light-emitting element 10 stops emitting light, the second light-emitting element 22 returns to emit light permanently.

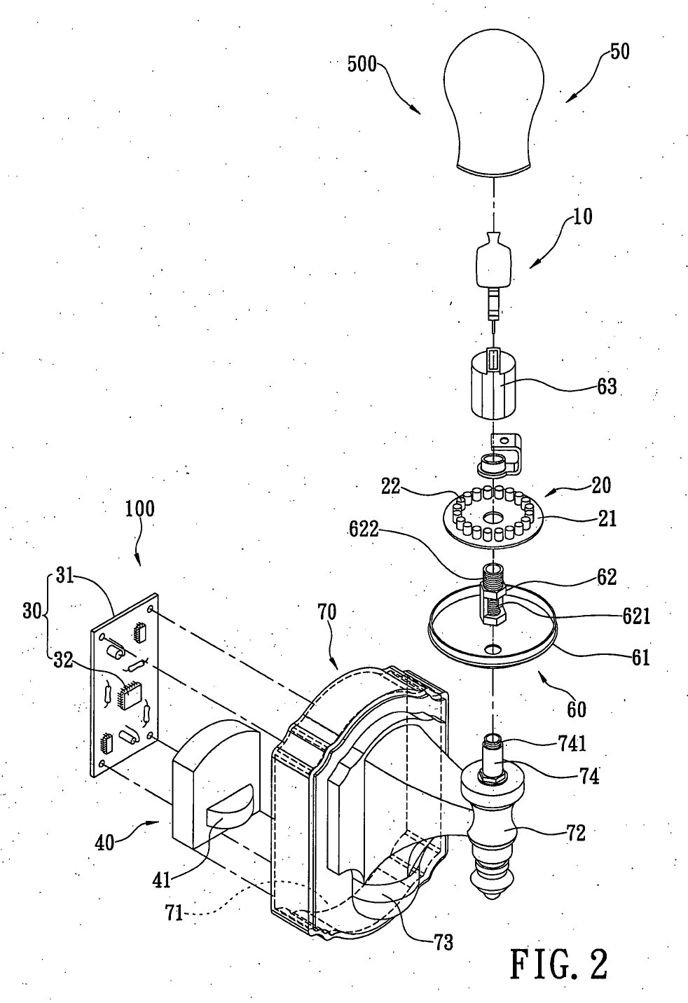

The first light-emitting element 10 and the second light-emitting element 22 can be the same kind or different kinds of luminous body as long as the feature of illumination intensity of the first light-emitting element 10 is higher than that of the second light-emitting element 22. The luminous body combination can be an incandescent bulb such as tungsten filament (FIG. 1), a halogen bulb with light emitting diode (FIG. 2), a fluorescent lamp with light emitting diode (not shown), an incandescent bulb with an incandescent bulb, light emitting diodes with light emitting diodes, etc.

In the figures of the present embodiment, the incandescent bulb is used as the first light-emitting element 10 and the second light-emitting element 22 comprises a plurality of light emitting diodes. The wattage and the power consumption of the light emitting diodes is only about 2 W which is much lower than that of incandescent bulbs (40 W˜100 W)

Further, the composite illumination module 100 of the present invention can be assembled in a lamp seat means 500. The lamp seat means 500 has a cover body 50, a fixing frame 60 and a fixing seat 70.

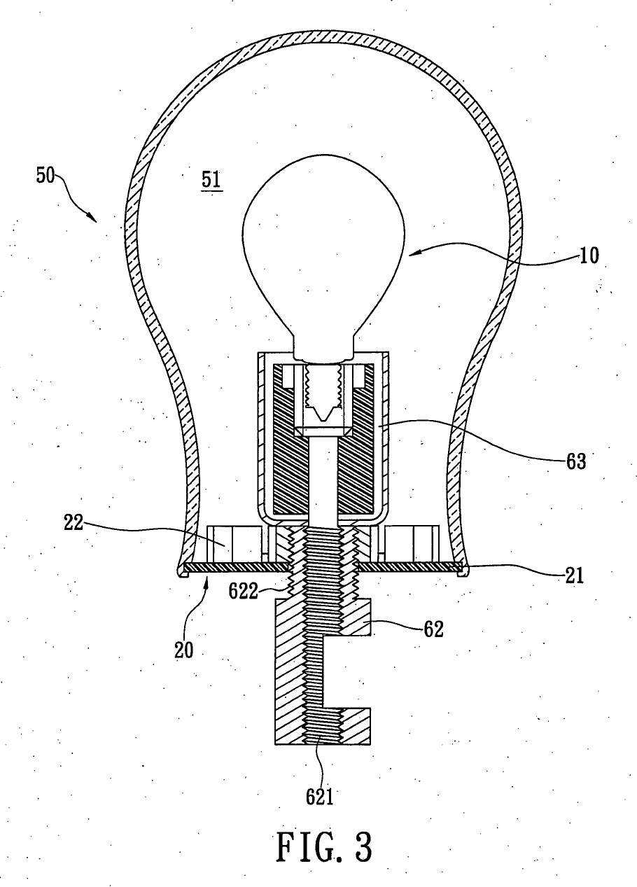

The profile of the cover body 50 is substantially designed as a spherical shape or a shape of incandescent bulb (as shown in FIG. 2). The material of the cover body 50 can be an opal or transparent glass having a light-transmitting as well as a light-condensing capacity. The interior of the cover body 50 is formed with an accommodating space 51 (FIG. 3).

The fixing frame 60 can be detachably assembled with the cover body 50. The fixing frame 60 has a chassis 61, a connecting piece 62, and a lamp leg seat 63. The inside and outside of the connecting piece 62 can be provided with inner threads 621 and outer threads 622, respectively. The lam leg seat 63 is connected to the connecting piece 62 with the outer threads 622 threadedly connected to the lamp leg seat 63. Of course, any equivalent connecting techniques such as engagement or insertion can be used.

If the first light-emitting element 10 is an incandescent bulb, it can be threadedly connected with the lamp leg seat 63 (FIG. 1). If it is a halogen bulb, it can be inserted into and thus connected to the lamp leg seat 63 (FIG. 2). The circuit board 21 of the light-emitting unit 20 can be provided at the outside of the connecting piece 62. If the second light-emitting element 22 is composed of a plurality of light-emitting diodes, they can be circumferentially provided on the surface of the circuit board 21. If it is a fluorescent lamp, it can be electrically connected on the circuit board (not shown).

The lamp leg seat 63 and the connecting piece 62 are received into the accommodating space 51 of the cover body 50, while the first and second light-emitting elements 10, 22 are commonly received into the accommodating space 51 (FIG. 3). The chassis 61 covers the bottom side of the cover body 50, thereby preventing foreign matter from entering the cover body 50.

The fixing seat 70 can be fixedly connected on a suitable site, such as an outdoor wall. The fixing seat 70 has an accommodating chamber 71, a supporting frame 72, an opening 73, and a connecting pillar 74.

One side of the fixing seat 70 is recessed inwardly to form the accommodating chamber 71 so as to accommodate the control circuit assembly 30 in the accommodating chamber 71. The opening 73 communicates with the accommodating chamber 71 so that the motion sensor 40 is received in the accommodating chamber 71 with a reflecting mask 41 of the motion sensor 40 protruding into the opening 73. The other side of the fixing seat 70 extends outwardly to form the supporting frame 72. The connecting pillar 74 is formed on the upper side of the supporting frame 72, and the outside thereof is formed with threads 741. The connecting pillar 74 penetrates through the chassis 61 so that the inner threads 621 of the lamp leg seat 63 are threadedly connected with the threads 741 of the connecting pillar 74, thereby to assemble the cover body 50, the first light-emitting element 10, and light-emitting unit 20 with the fixing seat 70.

According to the above description, when the motion sensor 49 of the composite illumination module 100 of the present invention does not detect the approach of any person or animal (creature), the control circuit assembly 30 can control the second light-emitting element 22 to permanently emit light. Light emitted thereby can be suitably condensed by means of the cover body 50 to avoid light from excessively scattering and thus providing an indication or guidance at a far distance. When the motion sensor 40 detects the approach of any person, it transmits a control signal to the control circuit assembly 30 and immediately controls the first light-emitting element 10 to activate to emit light, thereby providing the illumination for a close distance.

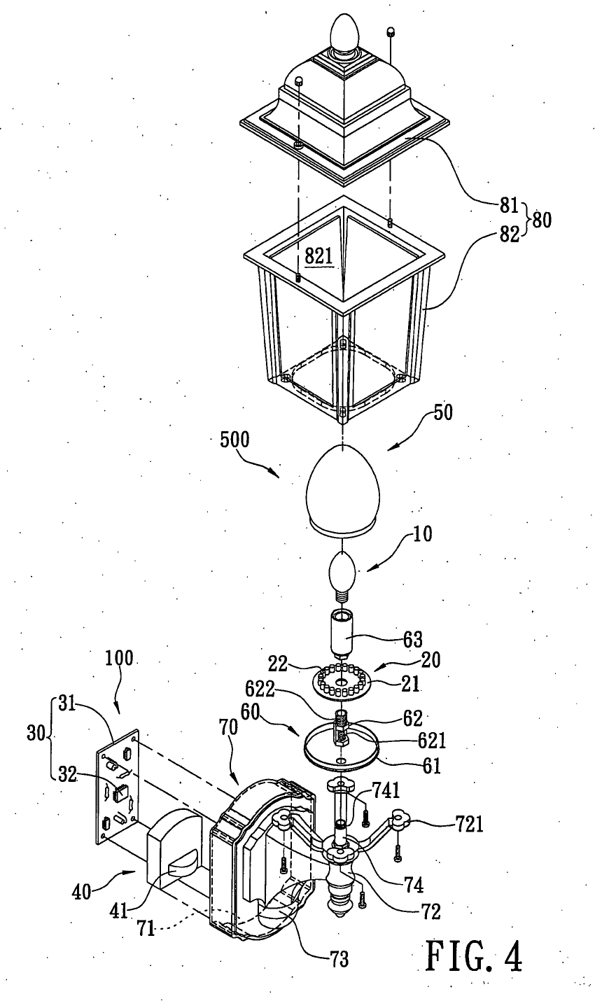

Further, with reference to FIG. 4 the user can modify the lamp seat means 500 according to his or her requirements. The present invention can be combined with a transparent external lamp housing 80 to cover and accommodate the bulb-like cover body 50, the first light-emitting element 10, and light-emitting unit 20.

More specifically, the external lamp housing 80 can have a top cover 81 and a light-transmitting frame 82 that are threadedly connected with each other. The interior of the light-transmitting frame 82 is formed with another accommodating space 821. The supporting frame 72 of the fixing seat 70 is further formed with four leg frames 721.

The light-transmitting frame 82 is combined with the fixing frame 70. The bottom side face of the light-transmitting frame 82 is provided on the leg frame 721 of the supporting frame 72. By means of screws, the leg frame 721 can be threadedly connected with light-transmitting frame 82. The cover body 59, the first light-emitting element 10, and light-emitting unit 20 are also received in the accommodating space 821. In this way, the external lamp housing 80 can provide an aesthetically visual effect as well as shielding from wind and rain. It is to be understood that the shape of the external lamp housing 80 can be designed according to the user's requirements. The external lamp housing 80 can also be designed and constructed with light transmitting and condensing glass or globe. In such case the cover body 50 is effectively merged with external lamp housing 80. The accommodating space 51 and the accommodating space 821 are unified. The drawings of the present invention only illustrate an embodiment, and the shape of the external lamp housing 80 of the present invention is not limited thereto.

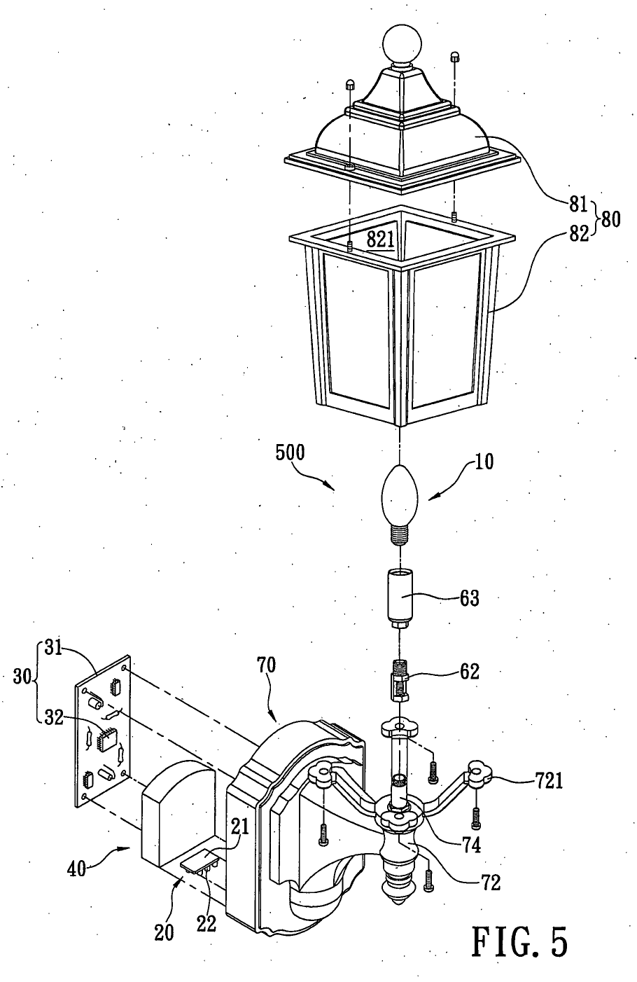

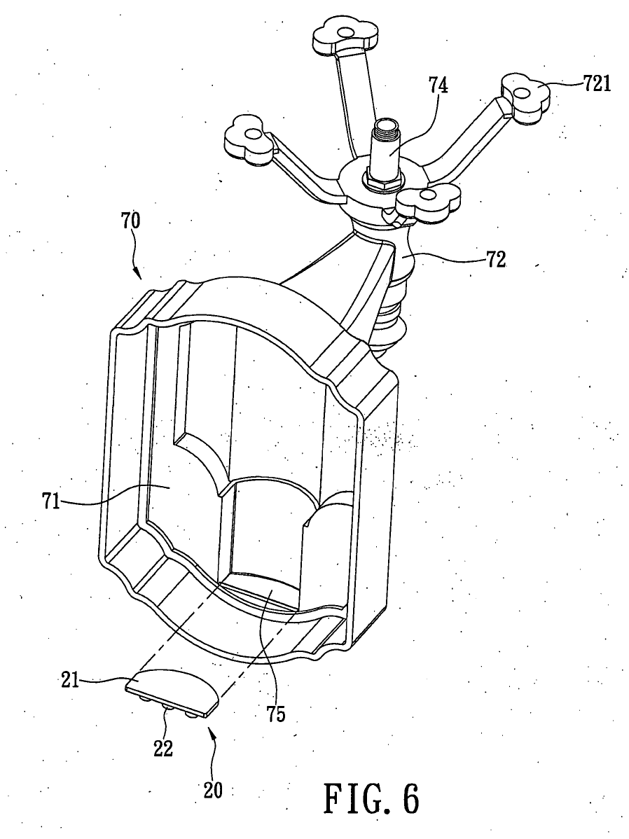

With reference to FIGS. 5 and 6, the light-emitting unit 20 can be disposed in an accommodating space 75 different from that of the first light-emitting element 10. The interior of the fixing seat 70 is further formed with another accommodating space 75 communicating with the accommodating space 71, thereby accommodating the light-emitting unit 20 in the accommodating space 75 of the fixing seat 70. The accommodating space 75 is constructed on the lower side of the fixing seat 70. Light-emitting unit 20 is electrically connected with the control circuit assembly 30 via the accommodating chamber 71. In this way, when the second light-emitting unit 22 of the light-emitting unit 20 emits light, light can be projected downwardly to act as an indirect illumination(Dark Sky illumination), thereby providing an efficient solution for light pollution control.

Further, in the present embodiment, the use of the cover body 50 can be further avoided, thereby reducing manufacturing costs.

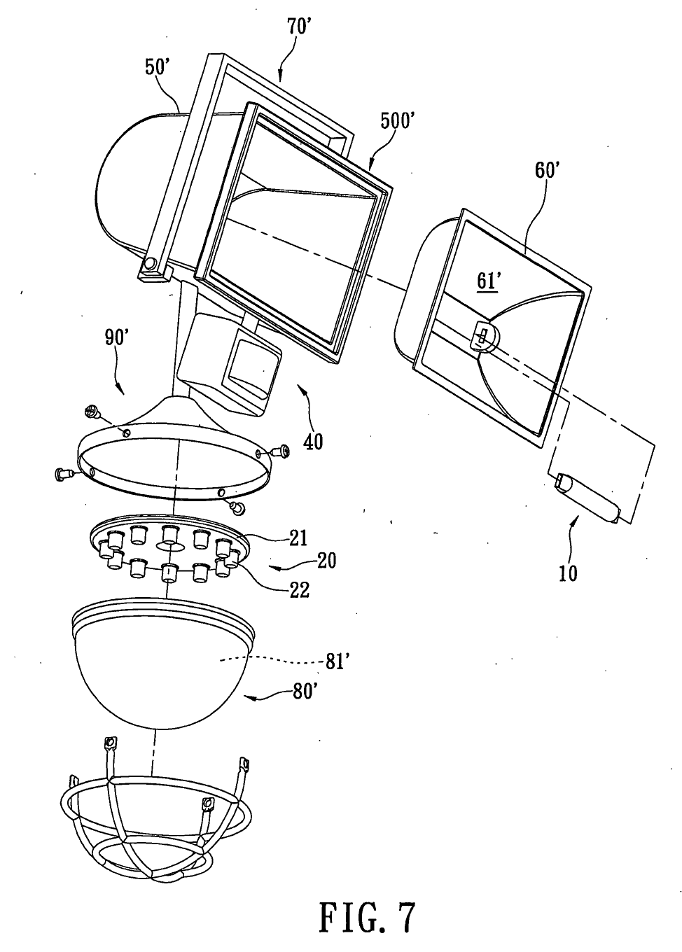

With reference to FIG. 7 an embodiment of another kind of lamp seat means 500′ is shown. The difference between the present embodiment and the previous one is in that there is an accommodating case 50′, a light-condensing mask 60′, a fixing frame 70 and a supporting frame assembly 90′. Further, it may have a cover body 80′.

The light-condensing mask 60′ is received in the accommodating case 50′. The light-condensing mask 60′ is formed into an accommodating space 61′ so as to accommodate the first light-emitting element 10 in the accommodating space 61′ of light-condensing mask 60′. The motion sensor 40 is connected to the lower side of the accommodating case 50′ and the control circuit assembly (not shown) is combined with the motion sensor 40. The supporting frame assembly 90′ is vertically connected to the lower side of the accommodating case 50′ for connecting and fixing the cover body 80′ and light-emitting unit 20. The cover body 80′ is formed with an accommodating space 81′ to accommodate the second light-emitting element 22. The fixing frame 70 is provided to dispose the accommodating case 50′ on a supported surface, such as a wall. With this arrangement, the first light-emitting element 10 and the second light-emitting 22 are received in two different accommodating spaces, respectively, to illuminate in two different directions. In the present embodiment, the first light-emitting element 10 illuminates forwardly while the second light-emitting element 22 illuminates downwardly.

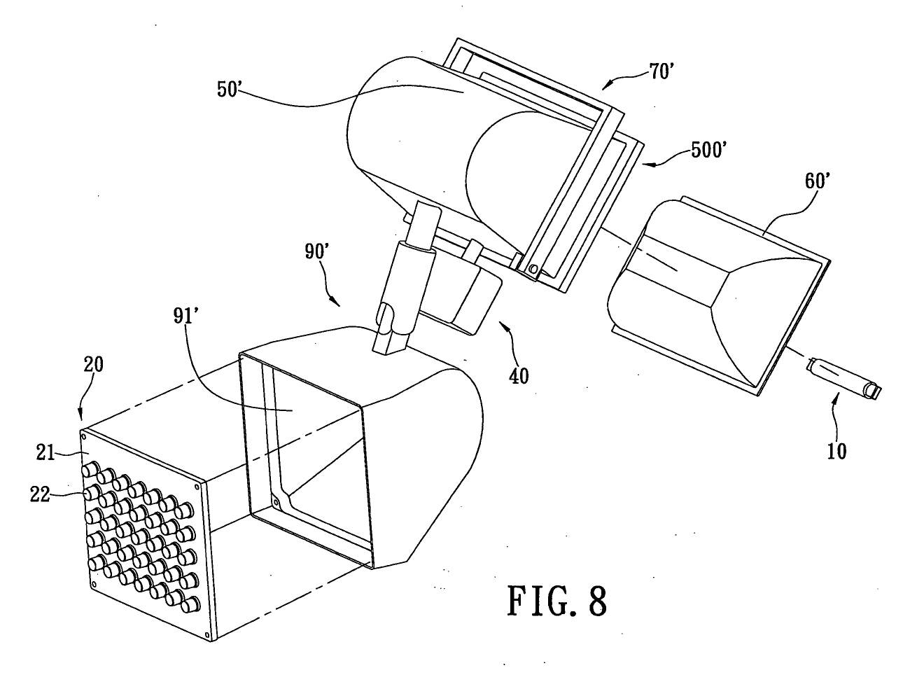

With reference to FIG. 8, the difference between the present embodiment and the previous lamp seat means 500′ is that the supporting frame assembly 90′ is obliquely connected to the lower side of the accommodating case 50′. The design shape of the supporting frame assembly 90′ is similar to that of the accommodating case 50′. The supporting frame assembly 90′ is formed with another accommodating space 91′ so that the light-emitting unit 20 can be disposed in the accommodating space 91′ of the supporting frame assembly 90′. In this way, the second light-emitting element 22 can illuminate an outdoor wall obliquely. For example, it can illuminate a house number plate on the outdoor wall.

The control circuit assembly 30 is further electrically connected to a photo sensor (not shown) for detecting whether the outdoor environment is bright or dark. If it becomes dark enough (subject to setting), it transmits a control signal to the control circuit assembly 30 to activate the second light-emitting element 22 to emit light.

According to the above, the present invention utilizes a second light-emitting element 22 having a low wattage and low electricity consumption. If light generated thereby can penetrate the cover bodies 50, 80′, light can be suitably refracted and thus uniformly emitted toward the surroundings of the mask bodies 50, 80′, thereby avoiding excessive concentration of light. In this way, an indicative or guiding effect for a far distance is provided, so that a person can recognize their surroundings or destination and accidents caused by a lack of light can be prevented. Further, when a person approaches, the second light-emitting element 22 having a low wattage can be switched to the first light-emitting element 10 having a larger wattage and high intensity, thereby providing a high-intensity illumination for a close distance. With the permanent light emission of the second light-emitting element 22 having a low wattage and low electricity consumption, power consumption can be substantially reduced.

In addition, the motion sensor 40 can be replaced by a digital switch (not shown) built in the circuit assembly and controlled by an indoor switch, whereby the user manually switches from the first light-emitting element 10 to the second light-emitting element 22 or vice versa. Thus, a similar or identical effect can be achieved. For example, when the digital switch is pressed, with the continuous actions of turning on/off/on, the first stage of turning on activates the second light-emitting element 22 to emit light, and the second stage of turning on actives the first light-emitting element 10 to emit light.

Alternatively, the motion sensor 40 and the digital switch may be both provided. The digital switch starts or stops light emission of the first and/or second light-emitting element 10, 22.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A composite illumination module, comprising:
at least one first light-emitting element;
a light-emitting unit having a circuit board and at least one second light-emitting element electrically connected to the circuit board, the second light-emitting element being a light-emitting diode, the wattage of the first light-emitting element being higher than that of the second light-emitting element;
a control circuit assembly electrically connected to the first light-emitting element and light-emitting unit, so as to electrically control the first and second light-emitting elements to selectively emit light; and
a motion sensor electrically connected to the control circuit assembly to detect the motion of approaching creatures and control light emission of the first light-emitting element.

2. The composite illumination module according to claim 1, wherein the first light-emitting element is a bulb.

3. The composite illumination module according to claim 2, wherein the bulb is a halogen, a tungsten filament or other incandescent bulb.

4. The composite illumination module according to claim 1, wherein the first and second light-emitting elements are commonly received in an accommodating space formed by a cover body or by an external lamp housing.

5. The composite illumination module according to claim 1, wherein the first and the second light-emitting elements are respectively received in different accommodating spaces to illuminate in two different directions.

6. The composite illumination module according to claim 1, wherein the control circuit assembly is electrically connected with a photo sensor.

7. A composite illumination module, comprising:
at least one first light-emitting element;
a light-emitting unit having a circuit board and at least one second light-emitting element electrically connected to the circuit board, the second light-emitting element being a light-emitting diode, the wattage of the first light-emitting element is higher than that of the second light-emitting element; and
a control circuit assembly electrically connected to the first light-emitting element and light-emitting unit, so as to electrically control the first and second light-emitting elements to selectively emit light, the control circuit assembly controlling the first light-emitting element to turn on or turn off via a digital switch on an indoor wall.

8. The composite illumination module according to claim 7, wherein the first light-emitting element is a bulb.

9. The composite illumination module according to claim 8, wherein the bulb is a halogen, a tungsten filament or an incandescent bulb.

10. The composite illumination module according to claim 7, wherein the first and second light-emitting elements are commonly received in an accommodating space formed by a cover body.

11. The composite illumination module according to claim 7, wherein the first and the second light-emitting elements are respectively received in different accommodating spaces to illuminate in two different directions.

12. The composite illumination module according to claim 7, wherein the control circuit assembly is electrically connected with a photo sensor.

13. A composite illumination module, comprising:
at least one first light-emitting element;
a light-emitting unit having a circuit board and at least one second light-emitting element electrically connected to the circuit board, the wattage of the first light-emitting element is higher than that of the second light-emitting element; and
a control circuit assembly electrically connected to the first light-emitting element and light-emitting unit, so as to electrically control the first and second light-emitting elements to selectively emit light.

14. The composite illumination module according to claim 13, wherein the first and second light-emitting elements are selectively the same kind or different kinds of luminous bodies.

15. The composite illumination module according to claim 14, wherein the luminous body is an incandescent bulb, a halogen bulb, a fluorescent lamp or a light-emitting diode.

16. The composite illumination module according to claim 13, wherein the first and second light-emitting elements are commonly received in an accommodating space formed by a cover body or an external lamp housing.

17. The composite illumination module according to claim 13, wherein the first and the second light-emitting elements are respectively received in different accommodating spaces to illuminate in two different directions.

18. The composite illumination module according to claim 13, wherein the control circuit assembly is electrically connected with a photo sensor.

19. The composite illumination module according to claim 13, wherein the control circuit assembly is further electrically connected with a digital switch on an indoor wall, thereby controlling the first light-emitting element to turn on or turn off.

20. The composite illumination module according to claim 13, wherein the control circuit assembly is electrically connected with a motion sensor, thereby detecting the approach of creatures and controlling light emission of the first light-emitting element.

21. A composite illumination module, comprising:
a first light-emitting unit accommodated in an upward lamp housing having a circuit board and a plurality of light-emitting diodes electrically connected to the circuit board.
a second light-emitting unit accommodated in an downward lamp housing having a circuit board and a plurality of light-emitting diodes electrically connected to the circuit board.
a control circuit assembly electrically connected to both the first light-emitting unit and the second light-emitting unit, so as to electrically control the first light-emitting unit and the second light-emitting unit to selectively emit light.

22. The composite illumination module according to claim 21, wherein the first light-emitting unit and the second light-emitting unit are respectively accommodated in different accommodating spaces to illuminate in two different directions.

23. The composite illumination module according to claim 21, wherein the control circuit assembly is electrically connected with a motion sensor, thereby detecting the approach of creatures and controls the light emission of the first light-emitting unit.

24. The composite illumination module according to claim 21, wherein the control circuit assembly is further electrically connected with a digital switch on an indoor wall, thereby controlling the first light-emitting unit to turn on or turn off.

25. The composite illumination module according to claim 21, wherein the control circuit assembly is further electrically connected with a photo sensor.
